(19) United States
(12) Patent Application Publication
(10) Pub. No.: US 2024/0235674 A1
(43) Pub. Date: Jul. 11, 2024

(54) OPTICAL TRANSMISSION CONTROL DEVICE, OPTICAL TRANSMISSION CONTROL METHOD, AND OPTICAL TRANSMISSION CONTROL PROGRAM

(71) Applicant: Nippon Telegraph and Telephone Corporation, Tokyo (JP)

(72) Inventors: Ken ITO, Musashino-shi, Tokyo (JP); Yasutaka SUGANO, Musashino-shi, Tokyo (JP); Takeshi KAWASAKI, Musashino-shi, Tokyo (JP); Hideki MAEDA, Musashino-shi, Tokyo (JP)

(21) Appl. No.: 18/558,625

(22) PCT Filed: May 10, 2021
(86) PCT No.: PCT/JP2021/017738

§ 371 Date: Nov. 2, 2023

(51) Int. Cl. H04B 10/079

(52) U.S. Cl. CPC H04B 10/07955; H04B 10/0799

(57) ABSTRACT

In the optical transmission system (1), a variable ATT (40) is used to attenuate both a data optical signal (L1) and an OSC optical signal (27) passing through a section according to an ATT value. A monitoring control server (50) includes an input unit (51) for receiving an input of information for specifying a monitoring section in the optical transmission system (1), an information collection unit (52) for collecting information for calculating an ATT value from a transmission device (20) and the variable ATT (40) existing in the monitoring section, and a change trial unit (54) for executing first determination processing for determining whether both of the optical signals can be transmitted, in accordance with whether or not power at the time of receiving the both optical signals passing through the monitoring section falls within a prescribed range, based on the information collected by the information collection unit (52).

### TECHNICAL FIELD

The present invention relates to an optical transmission control device, an optical transmission control method, and an optical transmission control program.

### BACKGROUND ART

An optical transmission system transmits an optical signal between a plurality of nodes. In an optical fiber connecting the preceding node and the next node of the optical transmission system, the transmission distance and the characteristics of the transmission line fiber are changed depending on the installation position of each node. Therefore, a method of automatically optimizing an input level of an optical signal according to a transmission distance is described in NPL 1. Thus, the characteristics of an optical AMP for receiving the optical signal in the node are guaranteed.

### CITATION LIST

### Non Patent Literature

[NPL 1] Tatsuo Nagayoshi and 4 others, “Automatic Input Level Adjustment Method for Optical Transmission Systems,” 2006 Joint Convention of Kyushu Branch of the Institutes of Electronics, 09-1A-04, 2006-9-21

### SUMMARY OF INVENTION

### Technical Problem

In addition to a main signal such as user data, an OSC (Optical Superposition Channel) optical signal which is a monitoring signal flows through the optical fiber of the optical transmission system. Therefore, adjustment of the optical levels of both signals becomes a problem.

FIG. 15 is a configuration diagram of an optical transmission system 100 with a single-vendor configuration.

The optical transmission system 100 is constituted by connecting a transmission transponder 110A, one or more transmission devices 120A, and a reception transponder 130A by optical fibers F1 to F3.

The transmission transponder 110A has an optical transmission unit 111A for converting an electric signal being a main signal such as user data into a data optical signal LA and transmitting it to the transmission device 120A.

The reception transponder 130A has an optical reception unit 131A for receiving the data optical signal LA from the transmission device 120A and converting it into an electric signal.

Note that the “A” at the end of the reference symbol of these optical transmission systems 100 indicates that they use devices provided by Vendor A.

The transmission device 120A is constituted of an OXC (Optical Cross Connect) or the like. The transmission device 120A transmits the data optical signal LA and an OSC optical signal 127A which is a monitoring signal on the same optical fiber (via an IF 129→IF 128) at different wavelengths. The OSC optical signal 127A is used to perform state monitoring processing of an optical amplifier in the OXC, setting control processing, and detection processing for detecting a transmission line failure between the OXCs. The data optical signal LA and the OSC optical signal 127A communicate in the same optical fibers F1 to F3. When the OSC optical signal 127A is too strong, the data optical signal LA is affected, so that the intensity of the OSC optical signal 127A is adjusted between the OSC transmission unit 125A and the OSC reception unit 126A.

FIG. 16 is a configuration diagram of the optical transmission system 100 with a multi-vendor configuration.

In this case, reducing equipment costs is considered by introducing a transmission transponder 110B manufactured by Company B instead of the transmission transponder 110A manufactured by Company A of FIG. 15, and introducing a reception transponder 130B manufactured by Company B instead of the reception transponder 130A manufactured by Company A of FIG. 15.

Note that the “B” at the end of the reference symbol of these optical transmission systems 100 indicates that they use devices provided by Vendor B.

Since the optical transmission unit 111B of the transmission transponder 110B transmits data optical signal LB of a modulation system conforming to the specification of Company B, an influence 140 (loss or the like) between the optical signal and the OSC optical signal 127A conforming to the specification of Company A may become a problem in the optical fibers F1 to F3.

In the case of the single-vendor configuration shown in FIG. 15, since the transmission power of the OSC optical signal 127A is set to match the modulation system of the data optical signal LA (optical transmission unit 111A), the influence 140 between both optical signals may not be considered.

On the other hand, in the case of the multi-vendor configuration shown in FIG. 16, since the transmission power of the OSC optical signal 127A is not designed in consideration of the modulation system of the other vendor, in some cases optical signals cannot be communicated between OXC and loss occurs.

Requesting Vendor A of the transmission device 120A to develop an additional adjustment of the transmit power of the OSC optical signal 127A to match the data optical signal LB of another vendor (Company B) is considered. However, this additional development is difficult for the following reasons.
The business strategy of Vendor A may not support the modulation scheme of other vendor.
Every time the type of transponder to be connected is increased (Company C, Company D and the like following Company B), new development is required in the transmission device 120A.
Even if the transmission device 120A corresponding to Vendor B is additionally developed, the transmission device 120A is replaced at all locations in the optical transmission system 100 in the actual operating environment, and there is concern that the equipment cost would be enormous.

Therefore, a main object of the present invention is to detect the influence between a main signal and a monitoring signal in the same optical fiber even when the modulation system of the main signal and the modulation system of the monitoring signal are different.

### Solution to Problem

In order to achieve the object described above, an optical transmission control device of the present invention has the following features.

The present invention is an optical transmission control device for controlling transmission of an optical transmission system,
wherein the optical transmission system is configured in such a manner that
a data optical signal transmitted from a transmission transponder is received by a reception transponder via a plurality of transmission devices,
a monitoring optical signal is transmitted and received in a section between adjacent transmission devices, and
an attenuator is used to attenuate both the data optical signal and the monitoring optical signal passing through the section according to an attenuation value, and
the optical transmission control device includes:
an input unit that receives an input of information for specifying a monitoring section in the optical transmission system;
an information collection unit that collects information for calculating the attenuation value from the transmission device and the attenuator existing in the monitoring section; and
a change trial unit that executes first determination processing for determining whether or not the both optical signals passing through the monitoring section can be transmitted, according to whether or not power at the time of receiving the both optical signals falls within a prescribed range, on the basis of the information collected by the information collection unit.

### Advantageous Effects of Invention

According to the present invention, the influence between the main signal and the monitoring signal can be detected in the same optical fiber even when the modulation system of the main signal and the modulation system of the monitoring signal are different.

### BRIEF DESCRIPTION OF DRAWINGS

FIG. 1 is a configuration diagram of an optical transmission system according to a present embodiment.

FIG. 2 is a configuration diagram of an optical transmission system including a monitoring control server according to the present embodiment.

FIG. 3 is a hardware configuration diagram of a monitoring control server according to the present embodiment.

FIG. 4 is a table showing a part of a database according to the present embodiment.

FIG. 5 is a table showing a part of the database according to the present embodiment different from that shown in FIG. 4.

FIG. 6 is a configuration diagram showing a state obtained after a transmission device is replaced for the optical transmission system according to the present embodiment shown in FIG. 1.

FIG. 7 is a configuration diagram showing a state obtained after an ATT value of a variable ATT is changed with respect to the optical transmission system according to the present embodiment shown in FIG. 6.

FIG. 8 is a flowchart showing the details of processing of the monitoring control server according to the present embodiment.

FIG. 9 is a table showing a part of a database obtained after replacement with a new transmission device according to the present embodiment.

FIG. 10 is a table showing a part of the database obtained after a temporary change is applied from a state of FIG. 9 according to the present embodiment.

FIG. 11 is a table showing a part of the database obtained after a temporary change is applied from a state of FIG. 10 according to the present embodiment.

FIG. 12 is a configuration diagram showing a state obtained after a transponder pair is replaced for the optical transmission system according to the present embodiment shown in FIG. 1.

FIG. 13 is a flowchart showing processing of the monitoring control server after replacement of the transponder pair described in FIG. 12 according to the present embodiment.

FIG. 14 is a table showing a part of the database obtained after replacement with a new transponder pair according to the present embodiment.

FIG. 15 is a configuration diagram showing an optical transmission system having a single-vendor configuration.

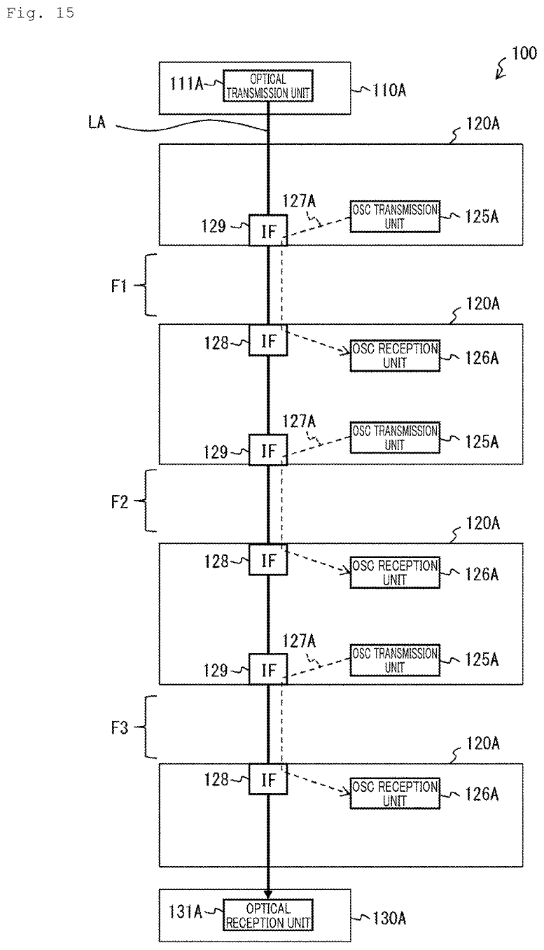

FIG. 16 is a configuration diagram showing an optical transmission system having a multi-vendor configuration.

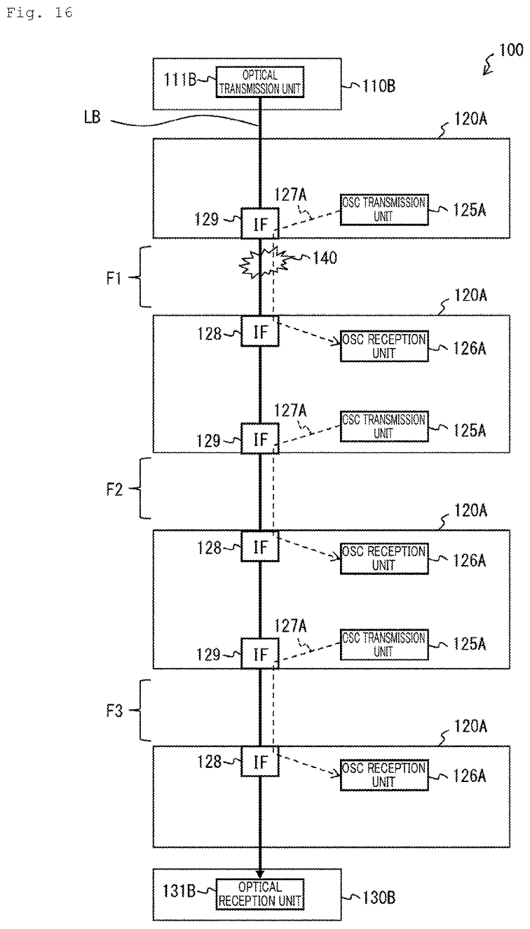

### DESCRIPTION OF EMBODIMENTS

An embodiment of the present invention will be described in detail below with reference to the drawings.

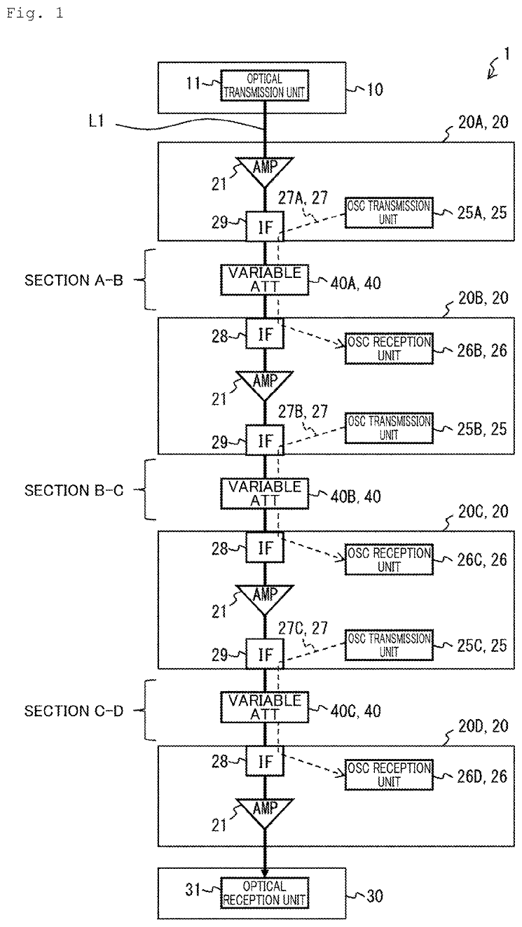

FIG. 1 is a configuration diagram showing an optical transmission system 1.

In the optical transmission system 1, a transmission transponder 10, transmission devices 20 (20A to 20D), and a reception transponder 30 are connected at sections A-B, B-C, C-D of an optical fiber.

The transmission transponder 10 includes an optical transmission unit 11 that converting an electric signal being a main signal such as user data into a data optical signal L1 and transmits the data optical signal L1 to the transmission device 20 (20A). The reception transponder 30 includes an optical reception unit 31 that receives the data optical signal L1 from the transmission device 20 (20D) and converts it into an electric signal.

Each transmission device 20 is constituted by OXC, REP (Repeater) or the like. The transmission device 20 transmits the data optical signal L1 amplified by an AMP 21 and an OSC optical signal 27 which is a monitoring signal, on the same optical fiber (via an IF 29→IF 28) at different wavelengths. The OSC optical signal 27 is used to perform state monitoring processing of an optical amplifier in the transmission device 20, setting control processing, detection processing for detecting a transmission line failure and the like between adjacent transmission devices 20. Both optical signals of the data optical signal L1 and the OSC optical signal 27 communicate in a section of the same optical fiber.

Since the data optical signal L1 is affected when the OSC optical signal 27 is too strong, a variable ATT (Attenuator) 40 is sandwiched between OSC transmission units 25 (25A to 25C) and OSC reception units 26 (26B to 26D).

The variable ATT 40 automatically adjusts the intensity of light passing through the optical fiber at its installed position. That is, the variable ATT 40 uniformly attenuates the light intensities of both of the passing optical signals by a predetermined ATT value (attenuation value).

Thus, since the intensity of light is adjusted outside the transmission device 20, the optical signal of a vendor different from the vendor of the transmission device 20 can be transmitted without developing/replacing the transmission device 20.

However, when the transmission device 20 and the transponders (the transmission transponder 10 and the reception transponder 30) are modified due to a failure or renewed, the communication of the optical signals may be affected by the individual difference between the devices and the difference between modulation system.

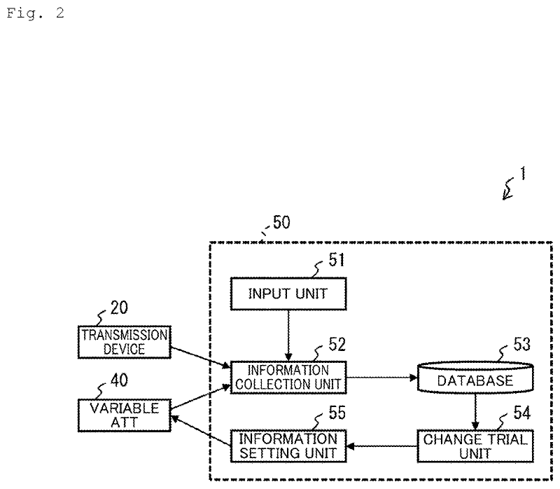

Thus, a monitoring control server (optical transmission control device) 50 shown in FIG. 2 for calculating the ATT value of the variable ATT 40 suitable for a new network configuration is newly prepared, with a change in the network configuration such as device replacement as a trigger.

FIG. 2 is a configuration diagram of the optical transmission system 1 including the monitoring control server 50.

The monitoring control server 50 includes an input unit 51, an information collection unit 52, a database 53, a change trial unit 54, and an information setting unit 55.

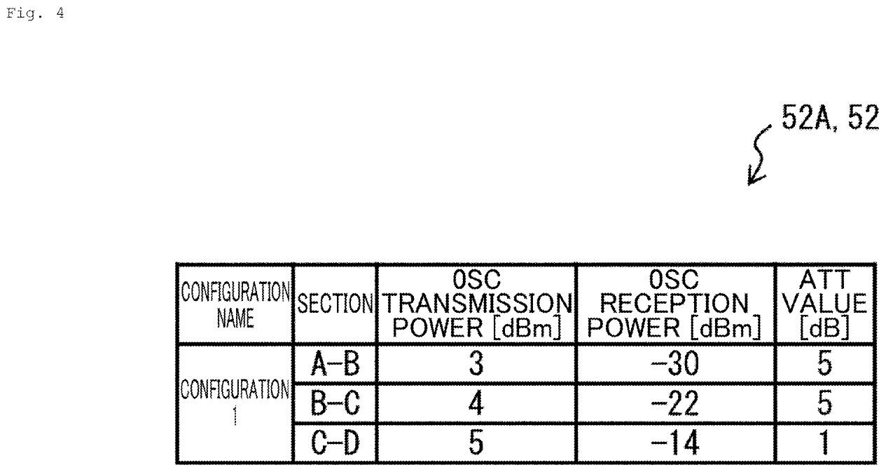

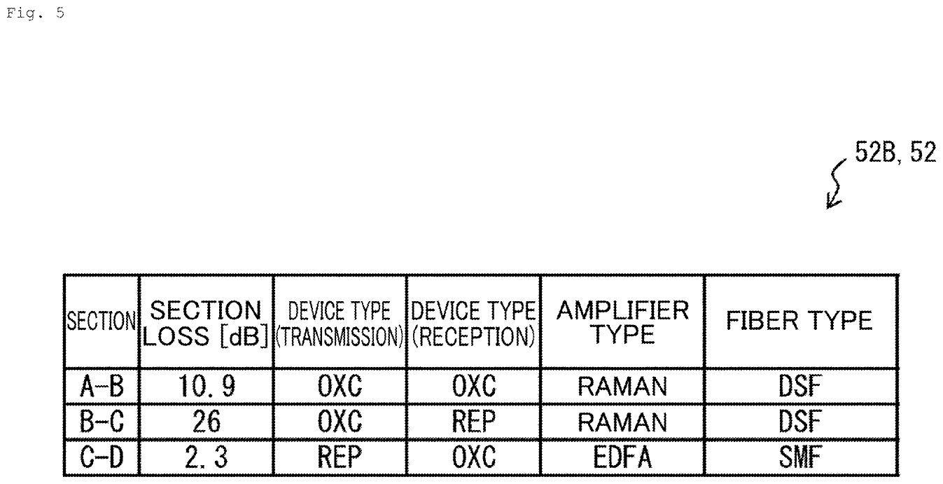

When the input unit 51 receives specific information of a monitoring section in the optical transmission system 1 (such as the configuration name, the number of sections, etc.) from an operator, the input unit 51 creates the database 53 from the specific information (details are shown in FIGS. 4 and 5).

The information collection unit 52 collects information (information for calculating the ATT value) used in processing by the change trial unit 54 from devices (the transmission devices 20 and the variable ATT 40) in respective sections registered in the database 53. This information collection is performed via a communication line such as an Ethernet @ cable via a router or a switch. Information collected by the information collection unit 52 is registered in the database 53.

The change trial unit 54 reads, from the database 53, the information collected by the information collection unit 52, and calculates an ATT value when the variable ATT 40 adjusts both of the optical signals flowing in the same optical fiber. Then, the change trial unit 54 tries (simulates) whether or not both of the optical signals can be transmitted, by applying the ATT value of the calculation result to the variable ATT 40.

The information setting unit 55 actually sets the ATT value of the calculation result confirming that there is no problem in the trial of the change trial unit 54, in the variable ATT 40.

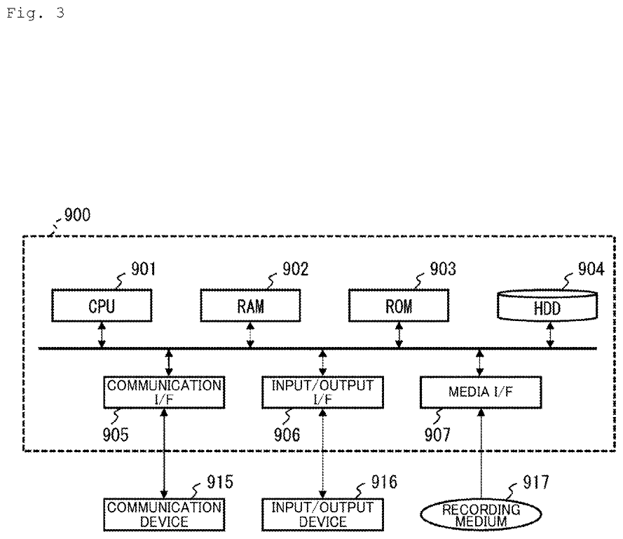

FIG. 3 is a hardware configuration diagram of the monitoring control device 50.

The monitoring control device 50 is configured as a computer 900 that includes a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to the input/output device 916. The media I/F 907 reads and writes data from and to the recording medium 917. Further, the CPU 901 controls each processing unit by executing a program (also called “application,” or “app” for short) read in the RAM 902. This program can also be distributed through a communication line or recorded and distributed on the recording medium 917 such as a CD-ROM.

FIG. 4 is a table showing a part of the database 53. In a table 52A, a configuration name of the optical transmission system 1, a section corresponding to the configuration name, an OSC transmission power [dBm] of the OSC optical signal 27 transmitted by the OSC transmission unit 25, an OSC reception power [dBm] of the OSC optical signal 27 received by the OSC reception unit 26, and an ATT value [dB] set in the variable ATT 40 are stored in association with each other.

The input unit 51 refers to correspondence data (not shown) between the configuration name and the section registered in advance upon reception of an input of the configuration name “configuration 1” and the number of sections thereof=3, to obtain the sections “A-B, B-C, C-D” corresponding to “configuration 1,” and registers the sections in the table 52A.

When the configuration name and the sections “A-B, B-C, C-D” thereof are registered in the table 52A, the information collection unit 52 collects other information stored in the table 52A of each section.

The first row of the table 52A registers that the ATT value=5 is set for the variable ATT 40A in the section A-B. The ATT value is set for attenuating OSC transmission power=3 of the OSC transmission unit 25A of the transmission device 20A to OSC reception power=−30 of the OSC reception unit 26B of the transmission device 20B.

FIG. 5 is a table showing a part of the database 53 different from that shown in FIG. 4.

When the sections “A-B, B-C, C-D” are registered in the table 52A, the information collection unit 52 collects information to be stored in the table 52B of each section. The table 52B stores the following information in association with each section.
Section loss [dB] of an optical signal passing through a section
Device type (transmission side or reception side of a section) of the transmission device 20.
Type of AMP 21 (amplifier type such as Raman, EDDA (Erbium doped Fiber Amplifier), etc.)
Type of optical fiber connecting the sections (DSF (Dispersion Shifted optical Fiber), SMF (Single-Mode optical Fiber), etc.)

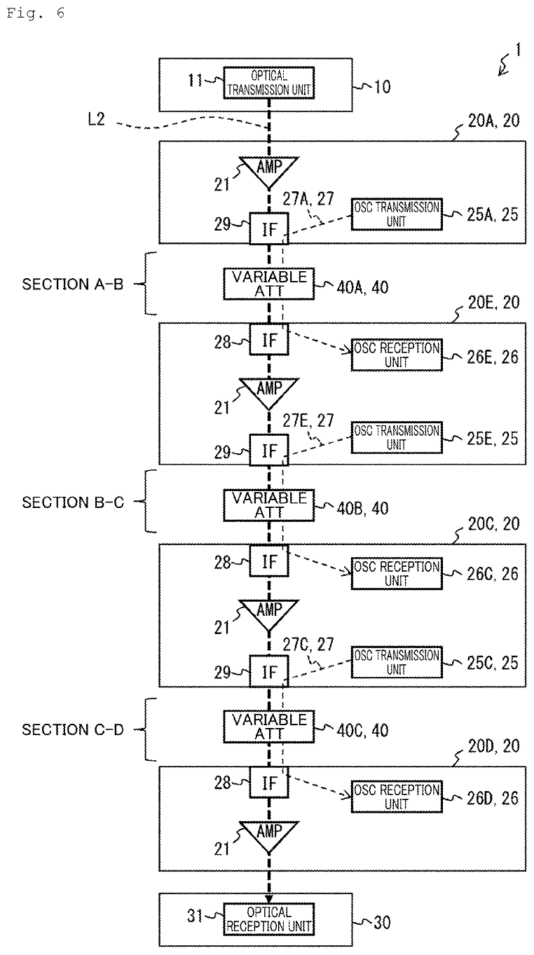

FIG. 6 is a configuration diagram showing a state obtained after the transmission device 20 is replaced for the optical transmission system 1 shown in FIG. 1.

The transmission device 20B shown in FIG. 1 that is positioned at the start point of the section B-C is replaced with the transmission device 20E of another vendor shown in in FIG. 6. Thus, the OSC optical signal 27E transmitted from the OSC transmission unit 25E of the transmission device 20E to the OSC reception unit 26C of the transmission device 20C is changed from the OSC optical signal 27B shown in FIG. 1.

Therefore, the variable ATT 40B of the section B-C needs to be changed to an ATT value so as to adjust the OSC optical signal 27E passing through itself. Before the ATT value is changed, the data optical signal L1 in FIG. 1 avoids loss caused by collision with the OSC optical signal 27E, temporarily stopping the transmission from the optical transmission unit 11 (reference symbol L2 indicated by a wavy line).

On the other hand, since the OSC reception unit 26E of the transmission device 20E is on the reception side of the OSC optical signal 27A and the transmission power of the OSC optical signal 27A is not changed, the ATT value of the variable ATT 40A of the section A-B does not need to be changed.

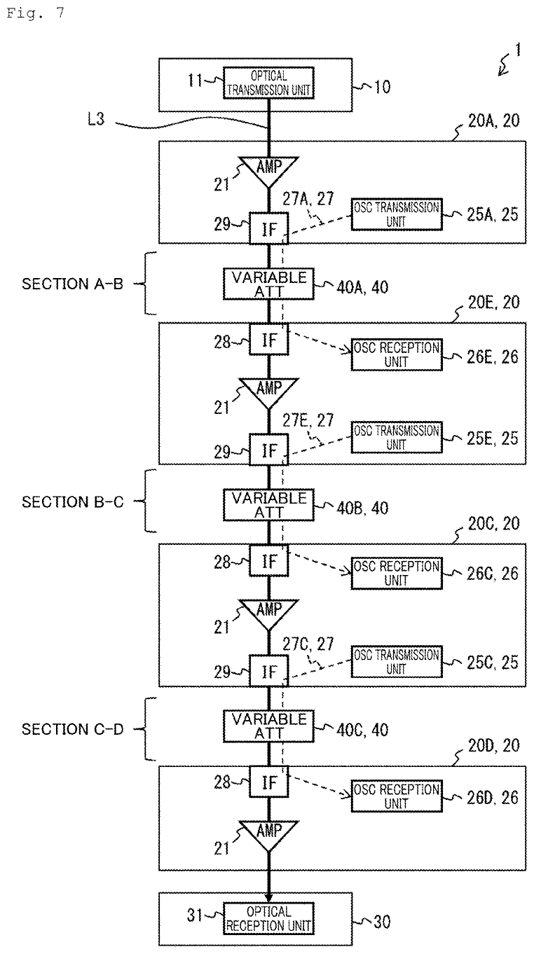

FIG. 7 is a configuration diagram showing a state obtained after the ATT value of the variable ATT 40B is changed with respect to the optical transmission system 1 of FIG. 6.

The information setting unit 55 actually sets the ATT value of the calculation result confirming that there is no problem in the trial of the change trial unit 54, in the variable ATT 40B. Thus, transmission of the temporarily stopped data optical signal L2 is restarted as a data optical signal L3 actually flowing in the optical fiber.

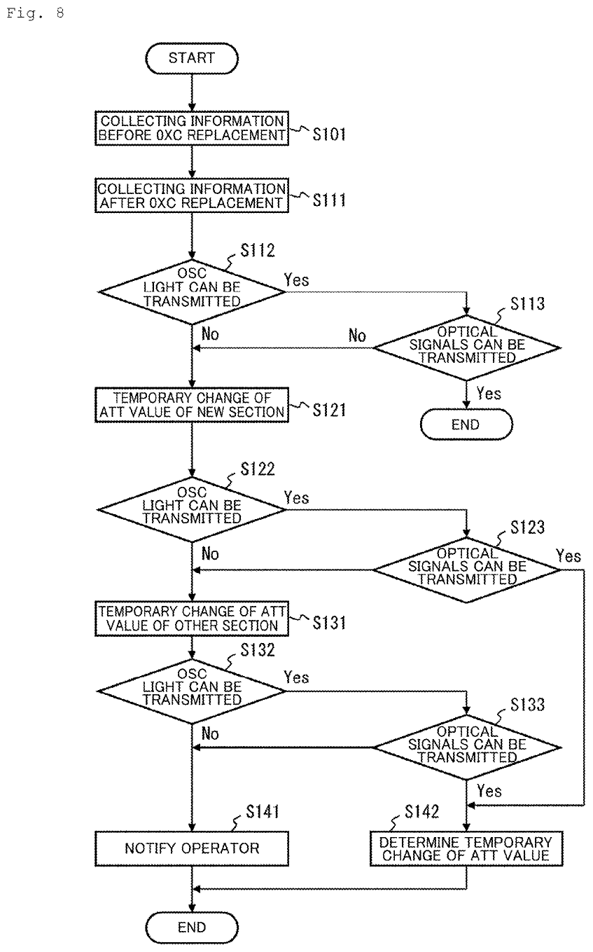

FIG. 8 is a flowchart showing the details of processing of the monitoring control server 50.

In preparation for this flowchart, the database 53 including “constitution name=configuration 1” and “sections=A-B, B-C, C-D” of a table 52A of FIG. 4 is created based on specific information of the monitoring section received by the input unit 51 (configuration name=configuration 1 and the number of sections=3).

In S101, the information collection unit 52 collects, from the device of each section (the transmission devices 20 and the variable ATT 40), the information necessary for calculating the ATT value of each of the sections=A-B, B-C, C-D written in the database 53, before replacing the transmission device (OXC) 20B of FIG. 1 with the transmission device 20E of FIG. 6, and adds the collected information to the database 53. The information required for calculating the ATT value includes the information (OSC transmission power, OSC reception power, ATT value) of the table 52A shown in FIG. 4, and information (section loss, device type on the transmission side, device type on the reception side, amplifier type, fiber type) of the table 52B shown in FIG. 5.

It is assumed that the transmission device 20B of FIG. 1 is replaced with the transmission device 20E of FIG. 6 (hereinafter referred to as “new transmission device”) after the processing of S101.

As S111, the input unit 51 receives, from the operator, an instruction to collect the same information as S101 related to the section B-C (hereinafter referred to as “new section”) in which the new transmission device transmits the OSC optical signal 27. The information collection unit 52 collects information necessary for calculating an ATT value from each device in the new section (new transmission device=transmission device 20E in FIG. 6, the transmission device 20C as a device adjacent thereto, and the variable ATT 40B in the new section), and updates the database 53 by the collected data.

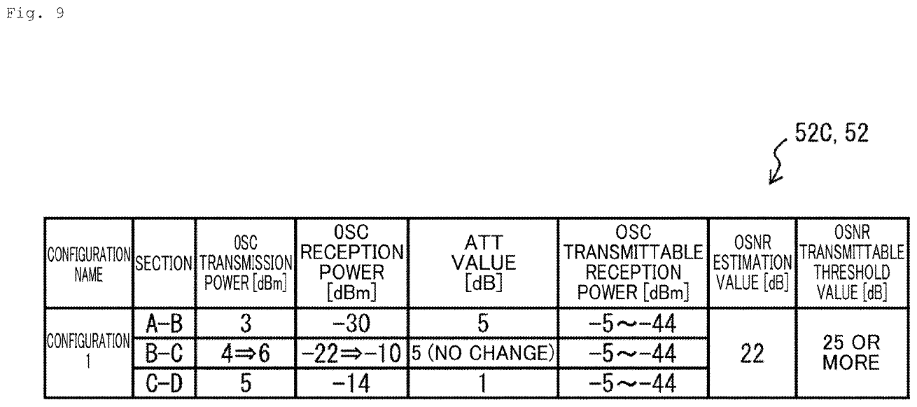

FIG. 9 is a table showing a part of the database 53 after the new transmission device has been replaced.

When compared with the table 52A of FIG. 4, a table 52C of FIG. 9 stores additional information estimated by the change trial unit 54 (OSC transmittable reception power [dBm], an OSNR (Optical Signal to Noise Ratio) estimation value [dB], and an OSNR transmittable threshold value [dB]) in association with each other.

Therefore, the change trial unit 54 estimates the additional information of the table 52C based on the information of the table 52C shown in FIG. 9 (OSC transmission power, OSC reception power, ATT value) and the information of the table 52B shown in FIG. 5 (section loss, transmission side device type, reception side device type, amplifier type, and fiber type).

As the updated contents of S111 in the new section B-C, the OSC transmission power transmitted by the new transmission device is changed from 4 to 6, and the OSC reception power of the transmission device 20C on the reception side is also changed from −22 to −10. On the other hand, at the point of S111, the ATT value is 5 and unchanged.

On the other hand, it is assumed that the contents of the table 52B shown in FIG. 5 are not changed before and after the replacement of the new transmission device.

In S112 shown in FIG. 8, the change trial unit 54 determines whether or not the OSC optical signal 27 can be transmitted in the new section on the basis of the information updated in S111. In the table 52C of FIG. 9, since the OSC reception power −10 after change is within the range of the OSC transmittable reception power −5 to −44, transmission is possible.

Next, the change trial unit 54 calculates an OSNR estimation value for estimating the reception power of the data optical signal L3 in the reception transponder 30 in the new section. In the table 52C shown in FIG. 9, the OSNR estimation value=22 is calculated.

Then, in S113, the change trial unit 54 determines whether the optical signal can be transmitted or not on the basis of the calculated OSNR estimation value. In the table 52C shown in FIG. 9, since the OSNR estimation value=22 is out of the range of the OSNR transmittable threshold value=25 or more, transmission is impossible.

If the results of both of the first determination processing (S112 and S113) are Yes (transmission is possible), since the new transmission device originally corresponds to the data optical signal L2 from the transmission transponder 10, it is not necessary to change the ATT value of the variable ATT 40 in the new section, and the processing is ended as-is.

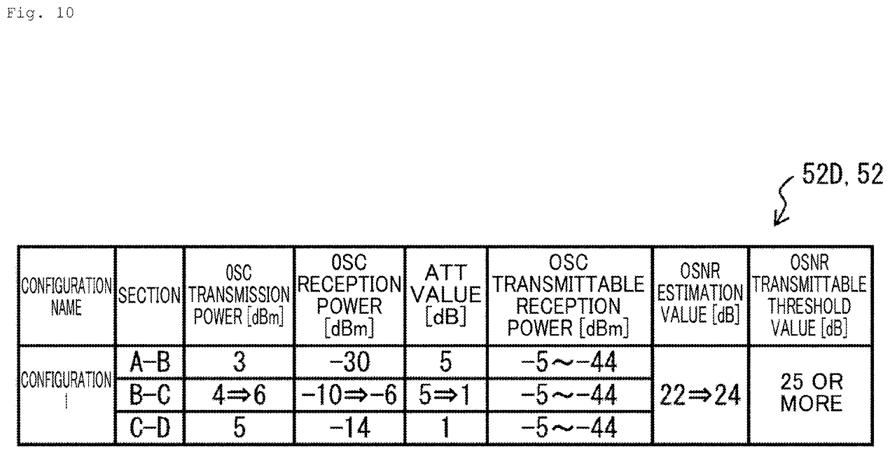

If the result of S112 of S113 is No, the change trial unit 54 temporarily changes the ATT value of the variable ATT 40 in the new section (S121). The temporary change is to try changing the ATT value of the variable ATT 40 in the monitoring control server 50 before actually changing the ATT value of the variable ATT 40. The OSC reception power and the OSNR estimation value of the new section affected by the temporary change of the variable ATT 40 are also changed. FIG. 10 is a table showing a part of the database 53 obtained after the temporary change of S121 is applied from the state shown in FIG. 9. In a table 52D, since the ATT value of the new section B-C is temporarily changed from 5 to 1, the OSC reception power of the new section B-C is also changed from −10 to −6, and the OSNR estimation value is also changed from 22 to 24.

In S122 in FIG. 8, the change trial unit 54 performs transmission possibility determination processing for the OSC optical signal 27 in the new section, similarly to S112, on the basis of the temporarily changed ATT value. Then, the change trial unit 54 performs transmission possibility determination processing (S123) for the optical signal in the same manner as S113.

If the results of the second determination processing (S122 and S123) are Yes (transmission is possible), the information setting unit 55 instructs to change the ATT value of the variable ATT 40 in the new section to determine the ATT value temporarily changed in S121 (S142).

In the table 52D shown in FIG. 10, since the OSC reception power 6 after the change is within the range of −5 to −44 of the OSC transmittable reception power, the transmission is possible in S122. However, since the OSNR estimation value=24 is out of the range of OSNR transmittable threshold value=25 or more, transmission is possible in S123.

If the result of S122 or S123 is No, the change trial unit 54 temporarily changes the ATT value of a section other than the new section temporarily changed in S121 (S131). The OSC reception power and the OSNR estimation value of the other section affected by the temporary change of the variable ATT 40 are also changed.

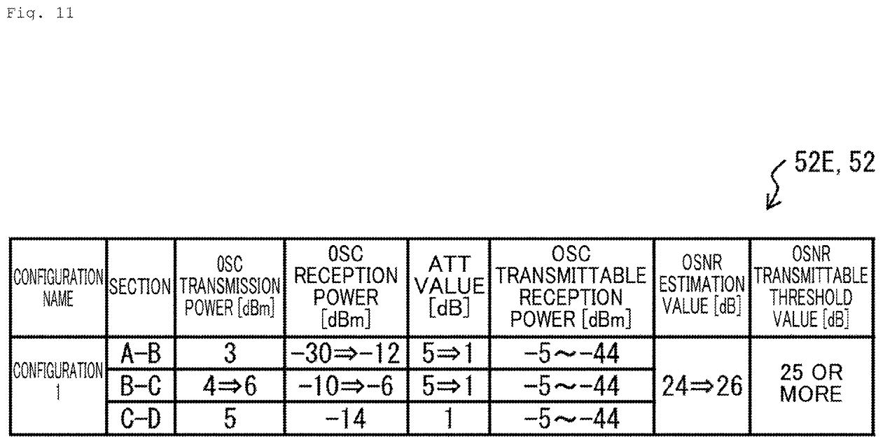

FIG. 11 is a table showing a part of the database 53 obtained after the temporary change of S131 is applied from the state shown in FIG. 10. In a table 52E, since the ATT value of the other section A-B is temporarily changed from 5 to 1, the OSC reception power of the other section A-B is also changed from −30 to −12, and the OSNR estimation value is also changed from 24 to 26.

In S132 in FIG. 8, the change trial unit 54 performs transmission possibility determination processing for the OSC optical signal 27 in the other section, similarly to S112, on the basis of the temporarily changed ATT value. Then, the change trial unit 54 performs transmission possibility determination processing (S133) of the optical signal in the same manner as S113.

In the table 52E of FIG. 11, since the OSC reception power −30 after the change is within the range of the OSC transmittable reception power −5 to −44, the transmission is possible in S132. Then, since the OSNR estimation value=26 is within the range of OSNR transmittable threshold value=25 or more, transmission is possible in S133.

If the results of the third determination processing (S132 and S133) are Yes (transmission is possible), the information setting unit 55 instructs to change the ATT value of the variable ATT 40 of each of the temporarily changed sections in order to determine the ATT value temporarily changed in S121 and S131 (S142).

If the result in S132 or S133 is No, the change trial unit 54 discards the temporary change of S121 and S131. Then, the change trial unit 54 notifies the operator that there is no ATT value which can be transmitted.

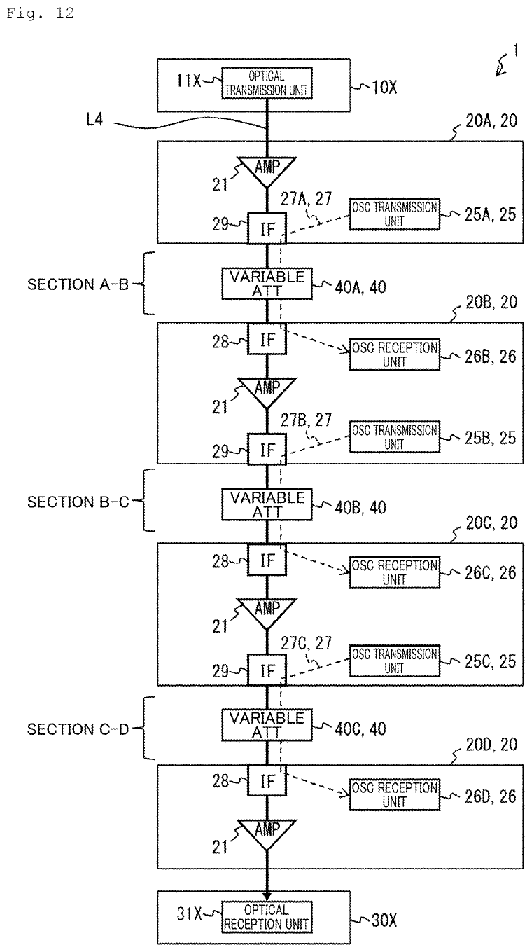

The process of adjusting the ATT value after the replacement of the transmission device 20 with respect to the optical transmission system 1 shown in FIG. 1 has been described with reference to FIGS. 6 to 11. In FIG. 12 and subsequent diagrams, the process of adjusting the ATT value after the replacement of the transmission transponder 10 and the reception transponder 30 (hereinafter referred to as “transponder pair”) with respect to the optical transmission system 1 shown in FIG. 1 will be described.

FIG. 12 is a configuration diagram showing a state obtained after the transponder pair is replaced for the optical transmission system 1 shown in FIG. 1.

The old transponder pair of a predetermined vendor shown in FIG. 1 is replaced with a new transponder pair (transmission transponder 10X and reception transponder 30X) of another vendor shown in FIG. 12. Thus, the data optical signal L4 transmitted from an optical transmission unit 11X of the transmission transponder 10X to an optical reception unit 31X of the reception transponder 30X is changed from the data optical signal L1 shown in FIG. 1. Therefore, all sections A-B, B-C, C-D in which the data optical signal L4 flows are affected.

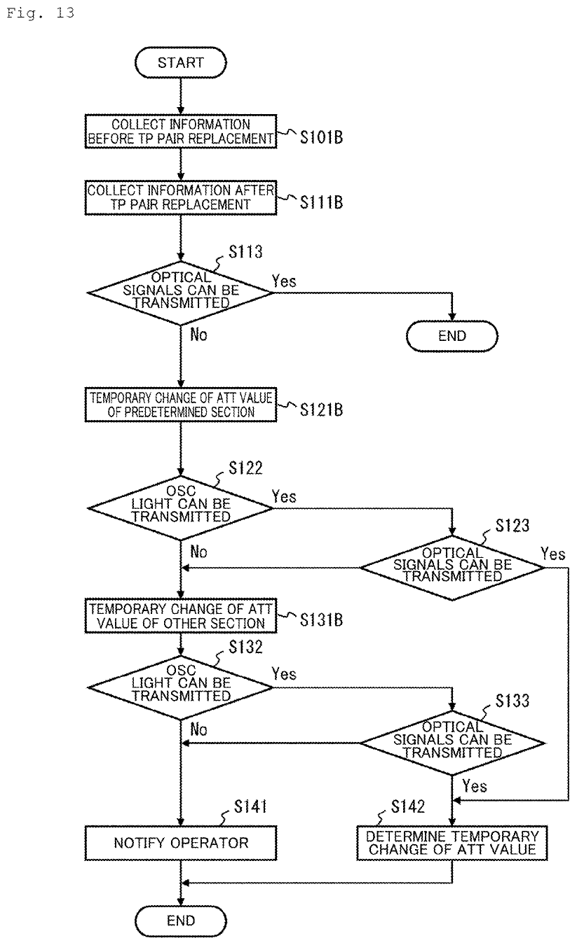

FIG. 13 is a flowchart showing the processing by the monitoring control server 50 after the replacement of the transponder pair described with reference to FIG. 12. Generally, the processing in the flow chart of FIG. 13 and the processing in the flow chart of FIG. 8 are similar to each other, but the description of the differences therebetween will be mainly described.

First, in processing for collecting information stored in the database 53, in S101 and S111 in FIG. 8, the information is collected before and after the replacement of the new transmission device. On the other hand, in S101B and SllB of FIG. 13, the information is changed so as to be collected before and after the replacement of the new transponder pair (TP pair). That is, in S111B, a section for collecting information is expanded to the sections=A-B, B-C, C-D where the data optical signal L4 of the new transponder pair passes.

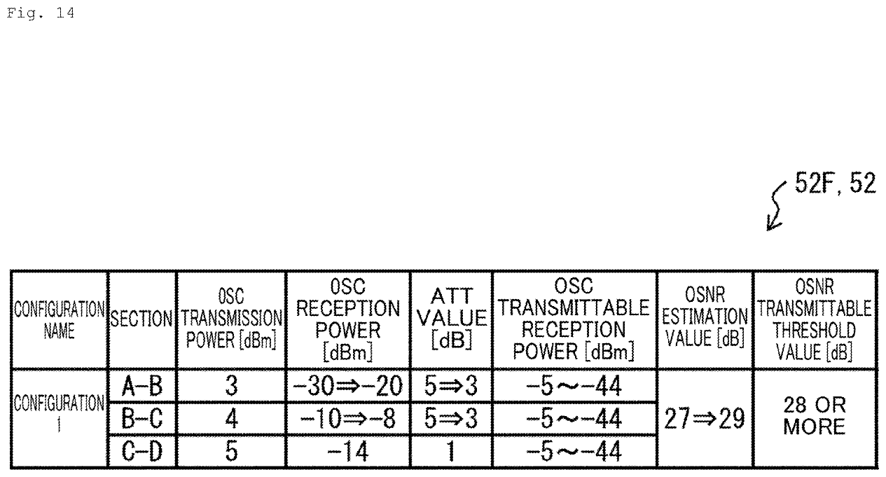

FIG. 14 is a table showing a part of the database 53 obtained after the replacement of the new transponder pair. In comparison with the table 52C of FIG. 9, in a table 52F of FIG. 14, the OSNR transmittable threshold value is changed to a value equal to or more than 28 corresponding to the replaced reception transponder 30.

On the other hand, since the transmission device 20 is not replaced in the replacement of the new transponder pair this time, the OSC transmission power of the table 52F is not changed in any section. Other modified parameters will be described later.

Returning to FIG. 13, in the processing before the temporary change of the ATT value, S112 (transmission possibility determination processing for the OSC optical signal 27) in FIG. 8 is omitted, and the change trial unit 54 executes processing (S113) for determining whether the optical signal can be transmitted or not on the basis of the calculated OSNR estimation value. If the result of S113 is Yes, the ATT value does not need to be changed, and the change trial unit 54 finishes the processing.

In the table 52F shown in FIG. 14, since the OSNR estimated value=27 prior to changing the ATT value is out of the range of the OSNR transmittable threshold value=28 or more, transmission is impossible (No in S113).

In FIG. 8, processing for temporarily changing the ATT value of the variable ATT 40 in the new section (S121) is performed. In FIG. 13, on the other hand, the change trial unit 54 temporarily changes the ATT value of the variable ATT 40 for a predetermined section among sections through which the data optical signal L4 passes instead of the new section (S121B). In the table 52F shown in FIG. 14, since the ATT value of the predetermined section B-C is temporarily changed from 5 to 3, the OSC reception power of the predetermined section B-C is also changed from −10 to −8. The predetermined section in Sl21B is, for example, a new section B-C obtained when the previous new transmission device is replaced.

The change trial unit 54 performs transmission possibility determination processing for the OSC optical signal 27 in a predetermined section in the same way as S112, on the basis of the ATT value temporarily changed in S121B (S122). Then, the change trial unit 54 performs transmission possibility determination processing (S123) for the optical signal in the same manner as S113. In the table 52F shown in FIG. 14, since the OSNR estimated value=27 obtained after the ATT value is changed in the predetermined section B-C is out of the range of the OSNR transmittable threshold value=28 or more, transmission is impossible (No in S123).

Further, the change trial unit 54 temporarily changes the ATT value of the variable ATT 40 existing in the other section A-B different from the predetermined section B-C of Sl21B (S131B). In the table 52F shown in FIG. 14, since the ATT value of the other section A-B is temporarily changed from 5 to 3, the OSC reception power of the other section A-B is also changed from −30 to −20 and the OSNR estimation value is also changed from 27 to 29.

Then, transmission becomes possible in both S132 and S133, and the information setting unit 55 transmits a control signal for determining the ATT value temporarily changed in Sl21B and S131B, to the variable ATT 40 (S142).

### Effects

The present invention is the monitoring control server 50 for controlling transmission of the optical transmission system 1, wherein the optical transmission system 1 is configured in such a manner that
the data optical signal L1 transmitted from the transmission transponder 10 is received by the reception transponder 30 via the plurality of transmission devices 20,
the OSC optical signal 27 is transmitted and received in a section between adjacent transmission devices 20, and
the variable ATT 40 is used to attenuate both the data optical signal L1 and the OSC optical signal 27 passing through the section according to an ATT value, and
the monitoring control server 50 includes:
the input unit 51 that receives an input of information for specifying a monitoring section in the optical transmission system 1;
the information collection unit 52 that collects information for calculating the ATT value from the transmission device 20 and the variable ATT 40 existing in the monitoring section; and
the change trial unit 54 that executes first determination processing for determining whether or not the both optical signals passing through the monitoring section can be transmitted, according to whether or not power at the time of receiving the both optical signals falls within a prescribed range, on the basis of the information collected by the information collection unit 52.

Thus, even when the transponder or the transmission device 20 is modified to the one of the other vendors, the influence between the main signal (data optical signal L1) and the monitoring signal (OSC optical signal 27) can be detected in the same optical fiber due to the difference of the modulation system between the vendors.

Therefore, there is no need to develop additional support in the transmission devices 20 for the transponders of other vendors or the transmission devices 20 of other vendors.

The present invention is characterized in that if it is determined in the first determination processing that transmission is impossible, the change trial unit 54 executes the second determination processing for determining whether or not power at the time of receiving the both optical signals is within a prescribed range, by changing the ATT value of the variable ATT 40 in a predetermined section where the transmission device 20 existing in the monitoring section is exchanged, on the basis of the information collected by the information collection unit 52.

Thus, by performing the second determination processing within the predetermined section in which the transmission device 20 is replaced, it becomes possible to follow the module individual difference obtained when the transmission device 20 is modified to another vendor.

The present invention is characterized in that if it is determined in the second determination processing that transmission is impossible, the change trial unit 54 executes third determination processing for determining whether or not the power at the time of receiving the both optical signals is within a prescribed range, by changing the ATT value of the variable ATT 40 in a section different from the predetermined section existing in the monitoring section, on the basis of the information collected by the information collection unit 52.

Thus, although the range of changing the ATT value in the third determination processing becomes a wide section, even if the transponder is modified to another vendor, it is possible to follow the module individual difference between the transponders (End-to-End).

According to the present invention, the monitoring control server 50 further includes the information setting unit 55, and
the information setting unit 55 performs control so as to change the ATT value of the variable ATT 40 in the optical transmission system 1 after the change trial unit 54 determines in the second determination processing or the third determination processing that the both optical signals can be transmitted by changing the ATT value of the variable ATT 40.

Thus, since only a trial (simulation) is performed within the monitoring control server 50 without changing the ATT value of the variable ATT 40 of the actual equipment until the both optical signals are determined to be ready for transmission, unnecessary attenuation of the both optical signals in the optical transmission system 1 can be suppressed.

The present invention is characterized in that, when it is determined in the third determination processing that at least one of the both optical signals cannot be transmitted even by changing the ATT value of the variable ATT 40, the change trial unit 54 notifies the outside that the ATT value which becomes transmittable cannot be calculated.

Thus, it is possible to prompt the operator early on to take measures other than changing the ATT value of the variable ATT 40 for optical signal loss caused by the replacement of the transponder or transmission device 20.

The present invention is characterized in that the change trial unit 54 calculates an OSNR (Optical Signal to Noise Ratio) estimation value on the basis of the information collected by the information collection unit 52 as the power at the time of receiving the data optical signal L1 passing through the monitoring section, and compares the OSNR estimation value with an OSNR transmittable threshold value for determining whether or not the OSNR estimation value is within a prescribed range.

Therefore, since the data optical signal L1 is not used as is to test whether the ATT value should be changed or not, there is no loss of customer data contained in the data optical signal L1.

### REFERENCE SIGNS LIST

1 Optical transmission system
10 Transmission transponder
11 Optical transmission unit
20 Transmission device
21 AMP
25OSC Transmission unit
26OSC Reception unit
27OSC Optical signal (monitoring optical signal)
30 Reception transponder
31 Optical reception unit
40 Variable ATT (attenuator)
50 Monitoring control server (optical transmission control device)
51 Input unit
52 Information collection unit
53 Database
54 Change trial unit
55 Information setting unit

1. An optical transmission control device for controlling transmission of an optical transmission system, comprising one or more processors configured to execute instructions that cause the optical transmission control device to perform operations comprising:
receiving an input of information for specifying a monitoring section in the optical transmission system, wherein the optical transmission system comprises a transmission transponder, a reception transponder, and a plurality of transmission devices, wherein a data optical signal transmitted from the transmission transponder is received by the reception transponder via the plurality of transmission devices, wherein a monitoring optical signal is transmitted and received in a section between adjacent transmission devices, and wherein an attenuator is configured t attenuate both the data optical signal and the monitoring optical signal passing through the section according to an attenuation value;
collecting information for calculating the attenuation value from the attenuator and a corresponding transmission device existing in the monitoring section; and
executing first determination processing to determine whether or not both the data optical signal and the monitoring optical signal passing through the monitoring section can be transmitted, according to whether or not power at a time of receiving both the data optical signal and the monitoring optical signal falls within a prescribed range, on a basis of the information collected.

2. The optical transmission control device according to claim 1, wherein in response to determining, in the first determination processing, that transmission is impossible, the one or more processors are configured to execute second determination processing to determine whether or not power at the time of receiving both the data optical signal and the monitoring optical signal is within a prescribed range, by changing the attenuation value of the attenuator in a predetermined section where the corresponding transmission device existing in the monitoring section is exchanged, on the basis of the information collected.

3. The optical transmission control device according to claim 2, wherein in response to determining, in the second determination processing, that transmission is impossible, the one or more processors are configured to execute third determination processing to determine whether or not the power at the time of receiving both the data optical signal and the monitoring optical signal is within a prescribed range, by changing the attenuation value of the attenuator in a section different from the predetermined section existing in the monitoring section, on the basis of the information collected.

4. The optical transmission control device according to claim 3,
wherein the one or more processors are configured to perform control so as to change the attenuation value of the attenuator in the optical transmission system after determining in the second determination processing or the third determination processing that both the data optical signal and the monitoring optical signal can be transmitted by changing the attenuation value of the attenuator.

5. The optical transmission control device according to claim 3, wherein the one or more processors are configured to notify outside that the attenuation value which becomes transmittable cannot be calculated when it is determined in the third determination processing that at least one of the data optical signal and the monitoring optical signal cannot be transmitted even by changing the attenuation value of the attenuator.

6. The optical transmission control device according to claim 1, wherein the one or more processors are configured to calculate an OSNR (Optical Signal to Noise Ratio) estimation value on the basis of the information collected as power at the time of receiving the data optical signal passing through the monitoring section, and compare the OSNR estimation value with an OSNR transmittable threshold value for determining whether or not the OSNR estimation value is within a prescribed range.

7. An optical transmission control method in which an optical transmission control device controls transmission of an optical transmission system, the optical transmission control method comprising:
receiving an input of information for specifying a monitoring section in the optical transmission system, wherein the optical transmission system comprises a transmission transponder, a reception transponder, and a plurality of transmission devices, wherein a data optical signal transmitted from the transmission transponder is received by the reception transponder via the plurality of transmission devices, wherein a monitoring optical signal is transmitted and received in a section between adjacent transmission devices, and wherein an attenuator is configured to attenuate both the data optical signal and the monitoring optical signal passing through the section according to an attenuation value;
collecting information for calculating the attenuation value from the attenuator and a corresponding transmission device existing in the monitoring section; and
executing first determination processing to determine whether or not both the data optical signal and the monitoring optical signal passing through the monitoring section can be transmitted, according to whether or not power at a time of receiving both the data optical signal and the monitoring optical signal falls within a prescribed range, on a basis of the information collected.

8. (canceled)

9. A non-transitory computer-readable medium storing program instructions that, when executed, cause one or more processors to perform operations comprising:
receiving an input of information for specifying a monitoring section in an optical transmission system, wherein the optical transmission system comprises a transmission transponder, a reception transponder, and a plurality of transmission devices, wherein a data optical signal transmitted from the transmission transponder is received by the reception transponder via the plurality of transmission devices, wherein a monitoring optical signal is transmitted and received in a section between adjacent transmission devices, and wherein an attenuator is configured to attenuate both the data optical signal and the monitoring optical signal passing through the section according to an attenuation value;
collecting information for calculating the attenuation value from the attenuator and a corresponding transmission device existing in the monitoring section; and
executing first determination processing to determine whether or not both the data optical signal and the monitoring optical signal passing through the monitoring section can be transmitted, according to whether or not power at a time of receiving both the data optical signal and the monitoring optical signal falls within a prescribed range, on a basis of the information collected.
